(19) United States
(12) Patent Application Publication
(10) Pub. No.: US 2007/0158890 A1
(43) Pub. Date: Jul. 12, 2007

(54) Drive device for actuating a linearly movable operative member

(75) Inventor: Luciano Migliori, Milan (IT)

Correspondence Address: YOUNG & THOMPSON, 745 SOUTH 23RD STREET, 2ND FLOOR, ARLINGTON, VA, 22202, US

(73) Assignee: Univer S.P.A., MILAN (IT)

(21) Appl. No.: 11/651,025

(22) Filed: Jan. 9, 2007

(30) Foreign Application Priority Data
Jan. 12, 2006 (IT) MI2006A000039

(51) Int. Cl. B23Q 3/08

(52) U.S. Cl. 269/32; 200/331

(57) ABSTRACT

The drive device for actuating a linearly movable operative member, comprises a box-shaped body for supporting a linearly movable operative member, actuating means for actuating the operative member, and a first and a second toggle-lever systems for connection between the operative member and the actuating means. The second toggle-lever system comprises a master lever, pivoted onto the box-shaped body and connected to the actuating means, and an intermediate connecting link, articulated to the master lever and operatively connected to the first toggle-lever system, the first toggle-lever system being in turn connected to the linearly movable operative member.

### BACKGROUND OF THE INVENTION

This invention concerns a drive device for actuating a linearly movable operative member, for example in the form of a centring, retaining or marking member for work pieces.

### STATE OF THE ART

It is generally known the use of drive devices for actuating linearly movable clamping members for retaining work pieces, which however, due to their specific structural features, exert limited clamping forces, unless use is made of expensive, high power actuating means.

DE 196 35 865, for example, discloses a clamping device for clamping work pieces, comprising a support body for supporting a clamping member linearly movable according to a longitudinal axis.

The device also comprises a toggle-lever system, designed to drive the linear movement of the clamping member, which in turn is provided with a first connecting link pivoted onto the support body and a second connecting link pivoted onto the clamping member, the first and the second connecting link being articulated to each other by means of a hinge pin.

The device furthermore comprises an intermediate connecting link, articulated between the hinge pin of the connecting links of the toggle-lever system and a drive element of an actuating cylinder, the drive element being movable perpendicularly to the longitudinal axis of the movable clamping member.

In a clamping device of this kind, the thrust exerted by the actuating cylinder is subjected to a limited multiplication by the toggle-lever system, upon which the final force that will be exerted by the clamping member depends; however, whenever high clamping forces are required, it is necessary to make use of actuating cylinders which provide an increased thrust force, with a consequent increase in costs and overall dimensions.

EP 1 524 079 also discloses a drive unit for operating clamping devices for retaining work pieces, comprising a box-shaped support body for supporting an operative clamping member, linearly movable according to a longitudinal axis.

The drive unit also comprises a drive element, such as a pneumatic or hydraulic cylinder, which is provided with a thrust element which extends parallel to the longitudinal axis of movement of the operative member, the thrust element being provided with a slider moving longitudinally to the box-shaped body.

The connection between the operative clamping member and the slider of the thrust element is achieved by means of a toggle-lever system and by an intermediate connecting link.

In particular, the toggle-lever system comprises a first and a second connecting link articulated to each other by means of a hinge pin, where the first connecting link is pivoted onto the box-shaped body and the second connecting link is pivoted onto the operative member, in such a way that, in correspondence with a forward clamping position of the operative member, the connecting links are oriented according to the longitudinal axis of the movable operative member itself.

The intermediate connecting link is articulated between the hinge pin of the connecting links of the toggle-lever system and the slider of the aforesaid thrust element.

Also for a drive unit of this kind, the thrust exerted by the actuating cylinder is multiplied by the toggle-lever system to a limited extent; therefore, whenever the clamping member is required to exert high clamping forces, it is still necessary to make use of actuating cylinders which provide an increased thrust force, with a consequent increase in the costs and overall dimensions of the drive unit itself.

### OBJECTS OF THE INVENTION

The object of this invention is to provide a drive device for actuating a linearly movable operative member, which is structurally simple, and which allows a significant multiplication of the force provided by the actuating means, thereby enabling the operative member to exert a considerably increased force, without the need to use more costly and cumbersome actuating means.

### BRIEF DESCRIPTION OF THE INVENTION

The above can be achieved by means of a drive device for actuating a linearly movable operative member, the device comprising:

a box-shaped body;

an operative member, linearly movable according to a longitudinal axis between a forward position and a backward position;

actuating means operatively connected to said linearly movable operative member;

a first toggle-lever system between said operative member and said actuating means, the toggle-lever system comprising a first and a second connecting links articulated to each other by means of a first hinge pin; and

a second toggle-lever system articulated between said first toggle-lever system and said actuating means, said second toggle-lever system in turn comprising:

a master lever, pivoted onto the box-shaped body and connected to said actuating means, and

an intermediate connecting link, the intermediate connecting link being articulated to said master lever and connected to the first hinge pin of said first and second connecting links of the first toggle-lever system.

### BRIEF DESCRIPTION OF THE DRAWINGS

These and further features according to this invention, will be more clearly evident from the following description with reference to the accompanying drawings, in which:

FIG. 1 shows a longitudinal cross-sectional view of the drive device according to this invention, in which the operative member is shown in a backward position; and

FIG. 2 shows a longitudinal cross-sectional view of the drive device of FIG. 1, in which the operative member is shown in a forward position.

### DETAILED DESCRIPTION OF THE INVENTION

The general features of this invention will be illustrated hereunder by means of an exemplificative embodiment.

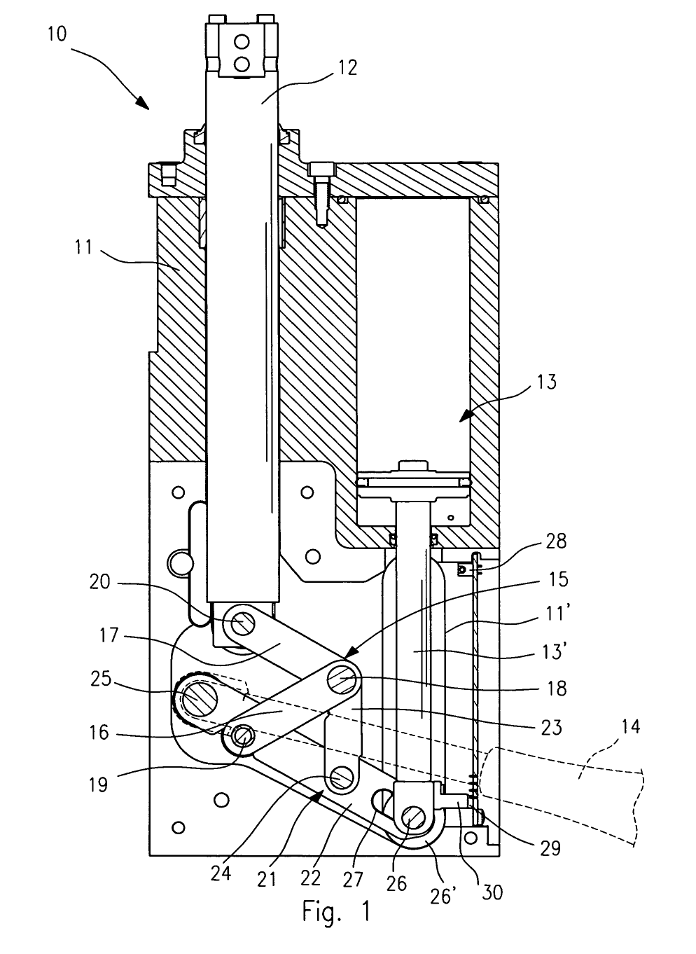

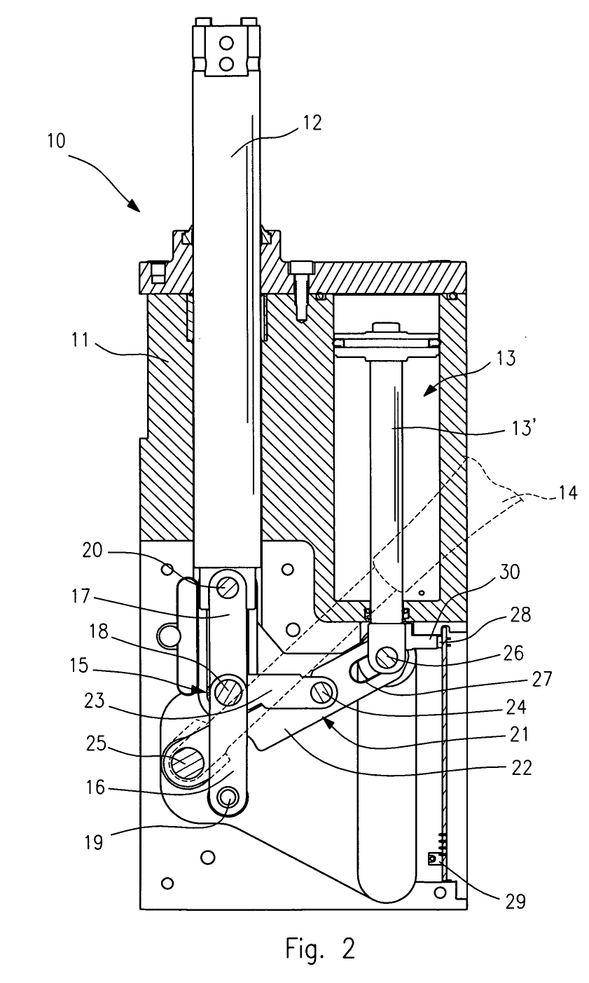

FIGS. 1 and 2 show a drive device according to this invention, for actuating a linearly movable operative member, for example in the form of a centring, retaining or marking member for work pieces.

The drive device, indicated as a whole by the reference number 10, comprises a box-shaped body 11 for supporting an operative member 12 linearly movable according to a longitudinal axis between a forward position and a backward position.

The device 10 also comprises actuating means operatively connected to the operative member 12, for example a linear actuator 13, such as a pneumatic cylinder, an electric cylinder or the like, and, alternatively or in combination, a manually operatable lever 14.

The device 10 also comprises a first toggle-lever system 15 between the operative member 12 and the actuating means 13, 14, which comprises a first and a second connecting links 16, 17 articulated with each other by means of a first hinge pin 18; furthermore, the first connecting link 16 has a pivotal pin 19 for pivoting it to the box-shaped body 11, while the second connecting link 17 has a connecting pin 20 for connecting it to the operative member 12.

The device 10 further comprises a second toggle-lever system 21, articulated between the first toggle-lever system 15 and the actuating means 13, 14; in particular, the second toggle-lever system 21 comprises a master lever 22 and an intermediate connecting link 23 articulated to each other by means of a second hinge pin 24.

The master lever 22 has a pivotal pin 25 for pivoting it to the box-shaped body 11 and is operatively connected to the actuating means 13, 14, while the intermediate connecting link 23 is connected to the first hinge pin 18 of the connecting links 16, 17 of the first toggle-lever system 15.

In the case illustrated in FIGS. 1 and 2, the actuating means comprise a pneumatic cylinder 13 housed in the box-shaped body 11 on a side of the operative member 12; the pneumatic cylinder 13 is provided with a drive element 13′ which is movable parallel to the longitudinal axis of the movable operative member 12.

The drive element 13′ is connected to the master lever 22 by a connecting pin 26 provided with suitable guide rollers 26′ sliding along respective sliding grooves 11′ in the box-shaped body 11.

As illustrated, the master lever 22 of the second toggle-lever system 21 is in the form of a second class inter-resistant lever, in which the pivotal pin 25 for pivoting it to the box-shaped body 11 is disposed on a first end, while on a second end the master lever 22 comprises a slot 27, which extends according to a longitudinal axis defined by the lever 22 itself, the axial slot 27 allowing the sliding and the articulation for the connecting pin 26 of the drive element 13′.

In this case, the second hinge pin 24 for the connection of the lever 22 with the intermediate connecting link 23 lies at an intermediate point of the same inter-resistant lever 22.

Preferentially, the pivotal pin 25 of the inter-resistant lever 22, with respect to the operative member 12, is connected to the box-shaped body 11 on a side opposite to the side on which the pneumatic cylinder 13 is housed.

The pivotal pin 19 of the first connecting link 16 and the connecting pin 20 of the second connecting link 17 of the first toggle-lever system 15 lie preferentially along the longitudinal axis of the movable operative member 12.

As illustrated in FIG. 2, in correspondence with the forward position of the operative member 12, the first and the second connecting links 16, 17 of the first toggle-lever system 15 are preferentially aligned with each other and with the longitudinal axis of the operative member 12, with the first hinge pin 18 between the connecting links 16, 17 which lies along the longitudinal axis of the operative member 12 itself.

Moreover, preferentially, the pivotal pin 25 of the inter-resistant lever 22, in the direction of the longitudinal axis of the operative member 12, is disposed in an intermediate position between the pivotal pin 19 of the first connecting link 16 and the connecting pin 20 of the second connecting link 17 of the first toggle-lever system 15.

The intermediate connecting link 23, in correspondence with the forward position of the operative member 12, preferentially forms an angle smaller than 90° with the first connecting link 16 of the first toggle-lever system 15.

In the event of a manually-operatable lever 14 being provided, the latter is connected to the pivotal pin 25 of the master lever 22, the master lever being integrally connected in rotation to the pivotal pin 25 itself.

Preferentially, the drive device 10 also comprises detecting means for detecting the position of the operative member 12, for example a first and a second position sensor 28, 29 supported by the box-shaped body 11 in such a way as to sense the position of a side protrusion 30 of the drive element 13′ of the pneumatic cylinder 13.

A drive device according to this invention, thanks to the second toggle-lever system, and in particular thanks to the second class master lever of the system, allows a significant multiplication of the force provided by the actuating means, thereby enabling the operative member to exert a considerably increased centring, retaining or marking force compared to the known devices.

Consequently, whenever the operative member is required to provide high forces, it is not necessary to make use of more powerful actuating means, which prove to be more costly and cumbersome.

What has been described and shown with reference to the accompanying drawings, has been given purely by way of example in order to illustrate the general characteristics of the invention, and of one of its preferential embodiments; therefore other modifications and variations to the drive device for actuating a linearly movable operative member are possible, without thereby deviating from the scope of the claims.

1. Drive device for actuating a linearly movable operative member, the device comprising:
a box-shaped body;
an operative member, linearly movable according to a longitudinal axis between a forward position and a backward position;
actuating means operatively connected to said linearly movable operative member;
a first toggle-lever system between said operative member and said actuating means, the toggle-lever system comprising a first and a second connecting links articulated to each other by means of a first hinge pin; and
a second toggle-lever system articulated between said first toggle-lever system and said actuating means, said second toggle-lever system in turn comprising:
a master lever, pivoted onto the box-shaped body and connected to said actuating means, and
an intermediate connecting link, the intermediate connecting link being articulated to said master lever and connected to the first hinge pin of said first and second connecting links of the first toggle-lever system.

2. Drive device according to claim 1, wherein said actuating means comprise a linear actuator having a drive element movable parallel to said longitudinal axis, the drive element being operatively connected to said master lever of the second toggle-lever system.

3. Drive device according to claim 2, in which the drive element of the linear actuator is provided with a connecting pin for connection to said master lever, wherein said master lever of the second toggle-lever system is in the form of a second class inter-resistant lever, comprising, on a first end, a pivotal pin for pivoting it to the box-shaped body, and, on a second end, a sliding and articulation slot for said pin of the drive element, the slot extending axially along the lever, and wherein a second hinge pin is provided for said intermediate connecting link, at an intermediate point of said inter-resistant lever.

4. Drive device according to claim 3, in which the linear actuator is housed in the box-shaped body on a side of said operative member, wherein the pivotal pin of said inter-resistant lever, with respect to said operative member, is connected to said box-shaped body on a side opposite to the side on which the linear actuator is housed.

5. Drive device according to claim 3, in which the first connecting link of said first toggle-lever system has a pivotal pin for pivoting it to said box-shaped body, and in which the second connecting link of the first toggle-lever system has a connecting pin for connecting it to said movable operative member, wherein said pivotal pin of the first connecting link and said connecting pin of the second connecting link of said first toggle-lever system lie along the longitudinal axis of the movable operative member.

6. Drive device according to claim 5, wherein, in correspondence with said forward position of the operative member, the first and the second connecting links of the first toggle-lever system are aligned with each other and with the longitudinal axis of the operative member, the first hinge pin between said first and second articulated connecting links lying along the longitudinal axis of the operative member itself.

7. Drive device according to claim 5, wherein the pivotal pin of the inter-resistant lever, in the direction of the longitudinal axis of the operative member, is disposed in an intermediate position between the pivotal pin of the first connecting link and the connecting pin of the second connecting link connecting it to the operative member.

8. Drive device according to claim 6, wherein the intermediate connecting link, in correspondence with said forward position of the operative member, forms an angle smaller than 90° with said first connecting link of the first toggle-lever system.

9. Drive device according to claim 1, in which the master lever of the second toggle-lever system has a pivotal pin for pivoting it to the box-shaped body, the master lever being integrally connected in rotation to the pivotal pin, wherein said actuating means comprise a manually-operatable lever connected to the pivotal pin of said master lever.

10. Drive device according to claim 2, in which the first connecting link of said first toggle-lever system has a pivotal pin for pivoting it to said box-shaped body, and in which the second connecting link of the first toggle-lever system has a connecting pin for connecting it to said movable operative member, wherein said pivotal pin of the first connecting link and said connecting pin of the second connecting link of said first toggle-lever system lie along the longitudinal axis of the movable operative member.
